(19) United States
(12) Patent Application Publication
(10) Pub. No.: US 2008/0254338 A1
(43) Pub. Date: Oct. 16, 2008

(54) Ion-conducting membrane and preparing method of same

(75) Inventors: Hiroki Uehara, Kiryu-shi (JP); Katsuhiko Nakajima, Nisshin-shi (JP); Masatoshi Matsuda, Toyota-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignees: TOYOTA JIDOSHA KABUSHIKI KAISHA; NATIONAL UNIVERSITY CORPORATION GUNMA UNIVERSITY

(21) Appl. No.: 12/078,302

(22) Filed: Mar. 28, 2008

(30) Foreign Application Priority Data
Mar. 30, 2007 (JP) 2007-091969

(51) Int. Cl. H01M 8/10

(52) U.S. Cl. 429/33; 264/104

(57) ABSTRACT

In an ion-conducting membrane, a polystyrene portion having ion conductivity and a polyethylene portion that forms a membrane skeleton together form a microphase-separated structure.

### INCORPORATION BY REFERENCE

The disclosure of Japanese Patent Application No. 2007-091969 filed on Mar. 30, 2007, including the specification, drawings and abstract is incorporated herein by reference in its entirety.

### BACKGROUND OF THE INVENTION

1. Field of Invention

The invention relates to a novel ion-conducting membrane. More particularly, the invention relates to an ion-conducting membrane with a low moisture content and high ion conductivity, as well as to a preparing method of that ion-conducting membrane.

2. Description of Related Art

Polymer material into which a cation-exchange group has been introduced is known. For example, Japanese Patent Application Publication No. 61-126105 (JP-A-61-126105) proposes an aromatic polymer film that has a microphase-separated structure into which a sulfonate group has been introduced.

That publication describes an ion-exchanger obtained by introducing a sulfonate group into a microphase-separated structure of a block copolymer of a polymer having a sulfonatable aromatic ring, and another polymer. The publication also describes a mixture of polyethylene and the polymer having the sulfonatable aromatic ring.

Meanwhile, a perfluorocarbon sulfonate membrane represented by Nafion™ is being widely considered as a polymer electrolyte membrane used in a polymer electrolyte fuel cell or the like. A perfluorocarbon sulfonate membrane has high proton conductivity and excellent chemical stability such as acid resistance and oxidation resistance. However, perfluorocarbon sulfonate membranes are extremely expensive due in part to the high cost of the raw materials used. Further, perfluorocarbon sulfonate membranes are known to have a high moisture content.

Polymer electrolyte membranes with high moisture content are used as electrolytes for fuel cells because water molecules are necessary as a proton transport medium. Also, water molecules which do not contribute to the conduction of protons through the membrane are known to exist in large numbers. This is thought to be because proton conducting channels are formed by chance. On the other hand, if the entire membrane is not moist, proton conductivity declines drastically so it is necessary to constantly keep the moisture content high. Also, comparing the resin component with water, the hydrogen or oxygen gas permeability coefficient of water is higher than that of resin, i.e., gas easily permeates a membrane that is moist so gas permeability becomes a significant problem as the moisture content increases.

Also, when a polymer electrolyte membrane has a high moisture content, the following problems were indicated for example: 1) When an MEA is made using this material, the electrolyte membrane itself expands and deforms by water absorption which reduces the contact with the electrode, and as a result, the structure of the MEA within the stack becomes uneven; 2) In order to prevent drying out at high temperatures, the fuel cell or the like must be operated at a relatively low temperature so high overall reaction efficiency is unable to be achieved; 3) Alternatively, the fuel cell or the like must be operated in very humid conditions in which case it is highly likely that moisture from an external source must be supplied; 4) Gas permeability is high so crossover is likely to occur.

Therefore, various proposals have been made regarding the chemical structure of a base polymer into which a sulfonate group is introduced (e.g., Japanese Patent Application Publication No. 2005-194517 (JP-A-2005-194517), Japanese Patent Application Publication No. 2006-269279 (JP-A-2006-269279), Japanese Patent Application Publication No. 2006-312739 (JP-A-2006-312739)).

JP-A-2005-194517 describes a proton-conducting membrane in which both a multi-ring aromatic polymer segment having a sulfonate group and a multi-ring aromatic polymer segment which does not have a sulfonate group have a microphase-separated structure. JP-A-2005-194517 also describes a preparing method of that proton-conducting membrane. However, there is no mention of the moisture content of the proton-conducting membrane.

JP-A-2006-269279 describes a polymer electrolyte membrane i) which includes at least two types of polymer compounds, i.e., a thermoplastic olefin elastomer having an aromatic unit and a polymer compound that does not have an aromatic unit, as essential units, and ii) in which a proton conductive group has been introduced into an aromatic unit within the polymer film. Also, polystyrene is given as an example of the thermoplastic olefin elastomer that has an aromatic unit, and polyethylene is given as an example of the polymer compound that does not have an aromatic unit. However, in this publication, there is no mention of a microphase-separated structure, neither is there mention of the moisture content of the polymer electrolyte membrane.

JP-A-2006-312739 describes a block copolymer which is made of a hydrophobic block and a hydrophilic block and has an acidic group in which these two blocks form a microphase-separated morphology. More specifically, with a block copolymer in which both blocks have multi-ring aromatic units, when the acidic group is a phosphonate group, the moisture absorption percentage (i.e., the moisture content) is 7% and the electrical conductivity at 80° C. and 26% RH is 0.0003 S/cm. When the acidic group is a sulfonate group, the moisture absorption percentage (i.e., the moisture content) is 70% and the electrical conductivity at 80° C. and 26% RH is 0.00009 S/m.

In this way, most known electrolyte membranes are polymers that have complicated chemical structures, and an electrolyte membrane with high ion conductivity and a low moisture content is unknown. That is, the electrolyte membranes described in the foregoing publications are unable to yield an ion-conducting membrane that has both a low moisture content and high ion conductivity.

### SUMMARY OF THE INVENTION

This invention provides an ion-conducting membrane that has both a low moisture content and high ion conductivity, as well as a preparing method of that ion-conducting membrane.

A first aspect of the invention relates to an ion-conducting membrane in which a polystyrene portion having ion conductivity and a polyethylene portion that forms a membrane skeleton together form a microphase-separated structure.

A second aspect of the invention relates to a preparing method of an ion-conducting membrane. This preparing method includes the steps of i) synthesizing a polyethylene-polystyrene block copolymer, ii) making the polyethylene-polystyrene block copolymer into a membrane, and iii) introducing an ion exchange group into a polystyrene portion of the polyethylene-polystyrene block copolymer.

According to the invention, an ion-conducting membrane that has both a low moisture content and high ion conductivity can be obtained.

### BRIEF DESCRIPTION OF THE DRAWINGS

The foregoing and further objects, features and advantages of the invention will become apparent from the following description of exemplary embodiments with reference to the accompanying drawings, wherein like numerals are used to represent like elements and wherein:

FIG. 1 is a cross-sectional photograph of the morphology of an example of an ion-conducting membrane of the invention.

### BRIEF DESCRIPTION OF THE DRAWINGS

The invention will now be described in more detail in terms of the following example embodiments: 1) the ion-conducting membrane in which the moisture content is no more than 10%, 2) the ion-conducting membrane which is given ion conductivity by a sulfone group, and 3) the ion-conducting membrane in which the polyethylene portion is obtained by hydrogen-reducing a polybutadiene portion of a styrene-butadiene block copolymer.

The ion-conducting membrane of the invention is such that a polystyrene portion having ion conductivity and a polyethylene portion that forms a membrane skeleton together form a phase-separated structure. The ion-conducting membrane can be obtained by introducing a substituent which is an ion source that accounts for ion conductivity into a polystyrene portion of a block copolymer having a membrane shape in which the polystyrene portion and a polyethylene portion that forms a membrane skeleton together form a microphase-separated structure.

The membrane-shaped block copolymer can be obtained by preferably hydrogen-reducing (hereinafter simply referred to as “hydrogenating”) the polybutadiene portion of the styrene-butadiene block copolymer. A degree of hydrogenation of double bonds in the polybutadiene portion of this block copolymer is preferably at least 90%. Also, the polyethylene portion is crystalline polyethylene. Crystallizing the polyethylene increases the strength of the skeleton which gives more stability to the shape, and as a result keeps the moisture content down. In this way, there is a skeleton reinforcement effect not seen in amorphous block copolymers. The crystallinity degree range is between 5 and 80%, inclusive, and more preferably between 10 and 50%, inclusive. The crystallinity degree can be calculated by the density method. The crystallinity degree is preferably high to maintain the skeleton (i.e., structural performance). Also, the ratio of the molecular weight (the mass average) of the polyethylene portion to the molecular weight of the polystyrene portion in the block copolymer is preferably 30000˜100000:20000˜80000, and the molecular weight distribution of the polymer body is preferably 1.1 or less.

The styrene-butadiene block copolymer can be obtained by living anion polymerization of styrene and butadiene. The polybutadiene portion of the styrene-butadiene block copolymer is preferably polybutadiene that essentially does not include a vinyl structure. The hydrogenation reaction of the polybutadiene portion block uses a catalyst appropriate for hydrogenation such as a butadiene polymerization catalyst, a hydrogenation catalyst that combines a transition metal such as Co or Ni with organic aluminum, or a hydrogenation catalyst made of a titanocene compound and organic aluminum or organic lithium. The hydrogenation conditions are all such that the reaction temperature is between 50 and 150° C. and the hydrogen pressure is approximately between normal pressure and 30 atmospheres.

The ions that are conducted in the ion conduction are not limited as long as they are able to move. For example, H⁺ (protons) may be used. Also, the substituent in the polymer that is the ion source that accounts for ion conductivity of the ion-conducting membrane is, for example, a sulfonate group such as —SO₃H, —SO₃⁻M⁺, —COOH, —COO⁻M⁺, —PO₃H₂, —PO₃H⁻M⁺, —PO₃²⁻M²⁺, or a combination a combination of these (where M is an alkali metal, an alkali earth metal, ammonium, or alkylammonium). Incidentally, a sulfonate group is preferable.

The ion-conducting membrane of the invention may be obtained through several steps. First, a block copolymer of the polystyrene portion and the polyethylene portion is made into a membrane which is then melted at preferably approximately 120 to 190° C. The melted membrane is then cooled to room temperature to crystallize the polyethylene portion preferably after being kept at a temperature of approximately 50 to 100° C. for at least 10 minutes, or more specifically, for between approximately 1 to 72 hours. In this isothermally crystallization processes, the bi-continuous structure of crystalline and amorphous phases is formed by phase-separation. Then, the process of providing an ion source is performed.

The block copolymer may be made into a membrane according to a melt casting method in which the block copolymer membrane is melted and cast into membrane shape, or a solution casting method in which the block copolymer is dissolved in a solvent and cast into membrane shape, and then the solvent is removed by drying. Of these, the solution casting method is the more preferable. An aromatic hydrocarbon such as toluene or xylene may be used as the solvent.

The ion source may be provided in one of two ways: 1) the block copolymer may be provided with an ion source first and then the membrane may be made, or 2) the membrane may be made first and then the ion source may be introduced. Of these, the method in which the ion source is introduced after the membrane is made is the more preferable. The ionization degree (i.e., the sulfonation degree when the ion source is a sulfone group) of the ion-conducting membrane of the invention is at least 90%, and preferably 100%. The ionization degree is 100% when one of five positions where a connection of the main chain of the polystyrene portion has not been applied is completely ionized. With this method, the membrane must be melted and cooled after it is made. As a result, the polyethylene portion crystallizes such that phase-separation is possible in the bi-continuous structure of crystalline and amorphous phases, which enables a low moisture content to be achieved. If the membrane is not melted and cooled after it is made such that there is no phase-separation in the bi-continuous structure of crystalline and amorphous phases, a low moisture content will not be achieved even if an ion source is simply given to the film.

One example of a method for providing the ion source is a method in which the block copolymer is reacted in a solvent that contains material for providing the ion source at a temperature between 0 and 100° C., preferably between 10 and 30° C., for at least 0.5 hours, preferably between 1 and 100 hours. A halogenated hydrocarbon, such as dichloroethane, 1-chloropropane, 1-chlorobutane, 2-chlorobutane, 1, 4-dichlorobutane, 1-chlorohexane, or chlorocyclohexane, may be used as the solvent.

When a sulfonate group is introduced as the ion source, it may be done in the following manner. For example, a membrane in which phase-separation was achieved in the block copolymer after the membrane was made, or a block copolymer before the membrane was made, is put into a sulfonating agent such as chlorosulfonic acid, oleum, sulfur trioxide-triethylphosphate, concentrated sulfuric acid, or trimethylsilylchlorosulfate, preferably the solvent solution of chlorosulfonate, and treated under the reaction conditions described above. The concentration of the sulfonating agent in the solvent is preferably approximately 0.01 to 1 mol/l, and preferably approximately 0.1 to 1 mol/l.

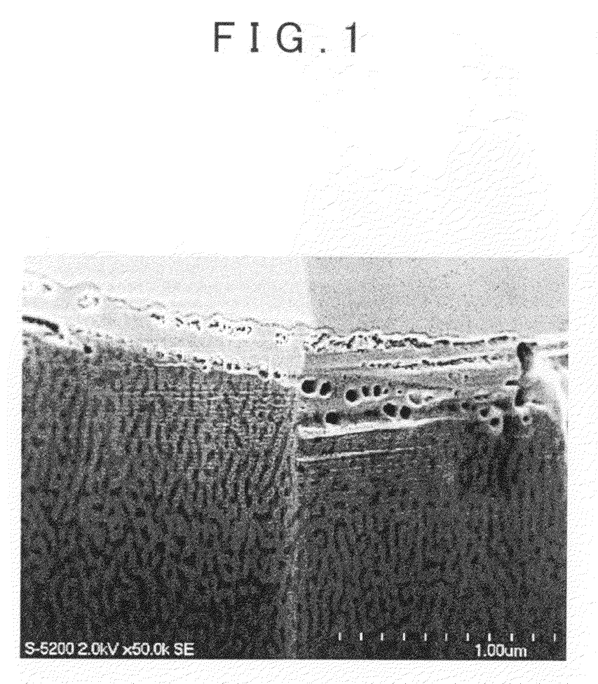

Hereinafter, the invention will be described with reference to FIG. 1 which is a cross-sectional photograph of the morphology of an example of the ion-conducting membrane of the invention. In FIG. 1, the ion-conducting membrane is such that a polystyrene portion having ion conductivity and a polyethylene portion that forms the skeleton of the membrane together form a microphase-separated structure. The size (width) of the mesh of the bi-continuous mesh structure is approximately 30 nanometers. The bi-continuous structure having such small size of the mesh is not formed simply by blending polystyrene and polyethylene together. The simple blend of polystyrene and polyethylene typically yields a phase-separated structure that is 1 μm or larger.

According to the invention, an ion-conducting membrane that has both a low moisture content and high ion conductivity without using a monomer having multiple aromatic rings is able to be obtained.

### EXAMPLES

Hereinafter, examples of the invention will be described. In each of these examples, the properties and the like of the ion-conducting membrane were obtained according to the following method.

1. Molecular Weight Measurement and Molecular Weight Distribution

The number average molecular weight and mass average molecular weight of a polystyrene portion and a polyethylene portion were measured using GPC (gel permeation chromatography), before the sulfonation process was performed. Polystyrene-b-ethylene (Mₙ 5.4×10⁴−6.7×10⁴, M_{W}/Mₙ=1.07) from Polymer Source, Inc. was used as the reagent.

2. Sulfonation Degree

Sulfonation degree (%)=(number of moles in the sulfonate group in the polymer after the sulfonation process/number of moles in the benzene ring)×100

3. Moisture Content

The weight of a film left in water overnight at room temperature (25° C.) so that it became saturated with water, and the weight of the film after being vacuum dried overnight at 25 to 60° C. were measured and the moisture content of each was obtained according to the following expression.

Moisture content (%)=(F_{W}−F_{D})×100/F_{D}

F_{W}: Weight of the water saturated film

F_{D}: Weight of the dried film

4. Proton Conductivity Measurement

The proton conductivity was measured using the AC impedance method under the condition that bias voltage was 0 V, the alternating current amplitude was 300 mV, and the measured frequency was 1˜2×10⁷ Hz.

5. Efficient Molecular Weight Per Sulfonate Group (E_{W})

The ion-exchange capacity (E_{W}) was obtained by calculation according to the following expression from the number average molecular weight after sulfonation and the styrene unit number in the block copolymer used for the raw material.

E_{W}=molecular weight per one sulfonate group

The polyethylene-polystyrene block copolymer that was obtained by hydrogenating the polybutadiene portion of a styrene-butadiene block copolymer (the degree of hydrogenation of double bonds in the polybutadiene portion being at least 90%, the molecular weight of the PE portion being 67000, the molecular weight of the PS portion being 54000, and the molecular weight distribution being 1.04) was dissolved at 130° C. in 1 percent by mass concentration of p-xylene. The solution was poured into a petri dish at room temperature and the solvent was removed by drying, such that a film formed. This film was then melted at 180° C. after which it was left at approximately 90° C. for 72 hours and then cooled to room temperature so as to obtain a membrane 25 μm thick. This membrane was then observed using a transmission electron microscope (TEM). Phase-separation of the polystyrene portion and the polyethylene portion that forms the membrane skeleton was observed using the TEM. The crystallinity of polyethylene portion in the membrane was 42.5% according to the density method.

The obtained membrane was then immersed in a dichloroethane solution (0.2 mol/l) of chlorosulfonate for 20 minutes at room temperature. The thus treated membrane was then washed with chloroform, acetone, and ion-exchange water, in that order, to remove any remaining reactant solution. Then the membrane was dried under reduced pressure at room temperature for at least six hours to obtain the ion (proton)-conducting membrane. This membrane was observed using a transmission electron microscope (TEM). Formation of a phase-separated structure by the polystyrene portion that includes the ion conductive group and the polyethylene portion that forms the membrane skeleton was observed using the TEM. Furthermore, a domain of the polyethylene portion and a domain of the polystyrene portion into which the ion conductive group was introduced formed a matrix, connecting together in a network as a bi-continuous mesh structure. Also, the proton-conducting membrane was evaluated. The results of that evaluation are as follows.

The moisture content (%) was 6.5%, the proton conductivity (at 50° C. and 90% RH) was 0.09 S/cm, the sulfonation degree was 100%, the efficient molecular weight per sulfonate group (E_{W}) was 313. Because the sulfonation degree was 100%, it is evident that only the polystyrene portion was sulfonated. The fact that the polyethylene component did not change even after the sulfonation treatment means that the material is ideal for maintaining function as the skeleton.

A commercially-produced perfluorocarbon sulfonate membrane was also evaluated as a comparative example. According to the evaluation results of that proton-conducting membrane, the moisture content (%) was 30%, the proton conductivity (at 50° C. and 90% RH) was 0.1 S/cm, and the efficient molecular weight per sulfonate group was 1000.

While the invention has been described with reference to example embodiments thereof, it is to be understood that the invention is not limited to the example embodiments or constructions. To the contrary, the invention is intended to cover various modifications and equivalent arrangements. In addition, while the various elements of the example embodiments are shown in various combinations and configurations, which are exemplary, other combinations and configurations, including more, less or only a single element, are also within the spirit and scope of the invention.

What is claimed is:

1. An ion-conducting membrane in which a polystyrene portion having ion conductivity and a polyethylene portion that forms a membrane skeleton together form a microphase-separated structure.

2. The ion-conducting membrane according to claim 1, wherein a moisture content is no more than 10%.

3. The ion-conducting membrane according to claim 1, wherein an ion conductive portion of the polystyrene portion is a sulfone group.

4. The ion-conducting membrane according to claim 1, wherein the polyethylene portion is obtained by hydrogen-reducing a polybutadiene portion of a styrene-butadiene block copolymer.

5. The ion-conducting membrane according to claim 4, wherein a degree of hydrogenation of double bonds in the polybutadiene portion is at least 90%.

6. The ion-conducting membrane according to claim 1, wherein an ion-conducting portion and a non-ion-conducting portion together of the ion-conducting membrane form a bi-continuous structure.

7. The ion-conducting membrane according to claim 6, wherein a mesh width of the bi-continuous structure is approximately 30 nanometers.

8. The ion-conducting membrane according to claim 1, wherein a crystallinity degree of the polyethylene portion is between 5 and 80%, inclusive.

9. The ion-conducting membrane according to claim 8, wherein the crystallinity degree of the polyethylene portion is between 10 and 50%, inclusive.

10. The ion-conducting membrane according to claim 1, wherein a molecular weight of the polyethylene portion is between 30000 and 100000, inclusive.

11. The ion-conducting membrane according to claim 10, wherein the molecular weight of the polyethylene portion is between 20000 and 80000, inclusive.

12. A preparing method of an ion-conducting membrane, comprising:
synthesizing a polyethylene-polystyrene block copolymer;
making the polyethylene-polystyrene block copolymer into a membrane; and
introducing an ion-exchange group into a polystyrene portion of the polyethylene-polystyrene block copolymer.

13. The preparing method according to claim 12, wherein first the polyethylene-polystyrene block copolymer is made into a membrane and then the ion-exchange group is introduced into the polystyrene portion of the polyethylene-polystyrene block copolymer.

14. The preparing method according to claim 12, wherein first the ion-exchange group is introduced into the polystyrene portion of the polyethylene-polystyrene block copolymer and then the polyethylene-polystyrene block copolymer into which the ion-exchange group has been introduced is made into a membrane.

15. The preparing method according to claim 12, wherein the polyethylene-polystyrene block copolymer is obtained by hydrogen-reducing a polybutadiene portion of a styrene-butadiene block copolymer.
